(19) United States
(12) Patent Application Publication
(10) Pub. No.: US 2009/0240174 A1
(43) Pub. Date: Sep. 24, 2009

(54) APPARATUS AND METHODS FOR THE PREVENTION OF VENOUS THROMBOEMBOLISM

(76) Inventor: Rudolph M. Keimowitz, Wayzata, MN (US)

Correspondence Address: CYR & ASSOCIATES, P.A., 605 U.S. Highway 169, Suite 300, Plymouth, MN, 55441, US

(21) Appl. No.: 12/399,205

(22) Filed: Mar. 6, 2009

Related U.S. Application Data
(60) Provisional application No. 61/034,736, filed on Mar. 7, 2008.

(51) Int. Cl. A61H 1/00

(52) U.S. Cl. 601/31

(57) ABSTRACT

Apparatus and methods for the prevention of venous thromboembolism are disclosed herein. The apparatus, in various aspects, includes a foot rocker having a foot support and one or more rockers engaged with the foot support. The one or more rockers are positionable between at least a storage position and a deployed position. Methods of use of the apparatus for prevention of venous thromboembolism are disclosed herein.

### CROSS-REFERENCE TO RELATED APPLICATIONS

The present application claims the priority and benefit of U.S. Provisional Application 61/034736 filed on Mar. 7, 2008, which is hereby incorporated by reference in its entirety herein.

### BACKGROUND OF THE INVENTION

The present disclosure relates to apparatus and methods for the prevention of venous thromboembolism and generally related morbidities.

It is generally recognized that stasis of the venous blood flow in the lower extremities contribute to thrombus formation. Sedentary life styles and periods of inactivity associated with, for example, periods of prolonged sitting such as experienced by travelers on an airplane on an extended journey or office workers generally confined to a desk for long hours may result in stasis of the venous blood in the feet and legs that could result in venous thromboembolism.

Various pharmaceuticals are available for the prevention of thromboembolism. These pharmaceuticals may act by thinning the blood (anticoagulants) thereby maintaining blood flow through the venous system to prevent thrombus formation. However, the pharmaceuticals may be expensive, require medical supervision, and may have side effects that may be significant. The use of pharmaceuticals may be contraindicated in some individuals.

Movement of the feet and legs that stimulates the flow of venous blood thereabout is recognized as a preventative measure, and, accordingly, various devices have been developed for use in stimulating the flow of blood in the feet and legs. However, a need still exists for an apparatus that may, for example, be carried about by a traveler and used to stimulate venous blood flow the feet and legs within the confines of an airplane or similar confined space.

### BRIEF SUMMARY OF THE INVENTION

These and other needs as well as various disadvantages of the related art may be overcome by the apparatus and methods disclosed herein. Additional improvements and advantages may be recognized by those of ordinary skill in the art upon study of the present disclosure.

In various aspects, the apparatus disclosed herein includes a foot rocker for the prevention of venous thromboembolism generally in the foot and leg. The foot rocker, in various aspects, includes a foot support adapted to generally receive at least portions of a plantar surface of a foot thereupon. In various aspects, a rocker is engaged with the foot support, and the rocker is positionable between a storage position and a deployed position. The rocker in the deployed position supports the foot support such that the foot support is oscillatable with a rocking motion stimulative to the foot and leg. The rocking motion of the foot support is stimulative to the foot and leg by causing dorsi flexion and plantar flexion of the foot engaged therewith that enhances venous blood flow thereabout in various aspects.

Methods for the prevention of venous thromboembolism generally in the foot and leg are disclosed herein. In various aspects, the methods may include the steps of positioning one or more rockers engaged with a foot support from a storage position into a deployed position, engaging at least portions of a plantar surface of a foot with a surface of the foot support following the step of positioning one or more rockers engaged with a foot support from a storage position into a deployed position, and causing dorsi flexion and plantar flexion of the foot by oscillating the foot support with at least portions of the plantar surface of the foot engaged therewith in a rocking motion upon the one or more rockers.

### BRIEF DESCRIPTION OF THE DRAWINGS

FIG. I illustrates by perspective view an exemplary implementation of a foot rocker;

FIG. 2 illustrates by a bottom view an exemplary implementations of the foot rocker and a second foot rocker;

FIG. 3A illustrates by side view and exemplary implementation of the foot rocker with a rocker positioned in the deployed position;

FIG. 3B illustrates by side view an exemplary implementation of the foot rocker with the rocker positioned in the storage position;

FIG. 4A illustrates by bottom view portions of an exemplary implementation of the foot rocker with the rocker in the storage position;

FIG. 4B illustrates by side cut-away view in general correspondence to FIG. 4A of portions of an exemplary implementation of the foot rocker with the rocker in the storage position;

FIG. 4C illustrates by bottom view portions of an exemplary implementation of the foot rocker with the rocker in the deployed position;

FIG. 4D illustrates by side cut-away view in general correspondence to FIG. 4C of portions of an exemplary implementation of the foot rocker with the rocker in the deployed position; and

FIG. 5 illustrates by cut away view portions of an exemplary male fitting and opposing socket.

The Figures are to facilitate explanation of the present invention. The number, position, relationship and dimensions of the parts shown in the Figures to form the various implementations described herein, as well as dimensions and dimensional proportions to conform to specific force, weight, strength, flow and similar requirements, are explained herein or are understandable to a person of ordinary skill in the art upon study of this disclosure. Where used in various Figures, the same numerals designate the same or similar parts. Furthermore, when the terms “top,” “bottom,” “right,” “left,” “forward,” “rear,” “first,” “second,” “inside,” “outside,” and similar terms are used, the terms should be understood in reference to the orientation of the structures shown in the drawings and utilized to facilitate understanding.

### DETAILED DESCRIPTION OF THE INVENTION

Apparatus and methods for the prevention of venous thromboembolism generally in the foot and leg are disclosed herein. The apparatus, in various aspects, includes a foot rocker having a foot support adapted to generally receive at least portions of a plantar surface of a foot thereupon. One or more rockers are engaged with the foot support. The one or more rockers are positionable between a storage position and a deployed position. When positioned in the storage position, the one or more rockers may generally assume a minimal aspect that may enhance the storability and portability of the foot rocker. The one or more rockers, when placed in the deployed position, support the foot support such that the foot support may oscillate upon the one or more rockers with a rocking motion generally stimulative to the foot and leg. This stimulation to the foot and leg, in various aspects, includes dorsi flexion and plantar flexion of the foot caused by the rocking motion of the foot rocker with the user's foot engaged therewith. The dorsi flexion and plantar flexion of the foot may enhance venous blood flow about the foot and leg and thus prevent stasis of venous blood flow and associated morbidities such as thrombus formation. So stimulating the foot may relieve edema including prevention and reduction of edema in the lower extremities including the foot and/or leg. The nerves and muscles in this region may be stimulated, and other therapeutic benefits may accrue. The other therapeutic benefits from the rocking motion may include substantially psychological benefits such as stress relief and general relaxation, which could have physiological manifestations.

Accordingly, in order to deliver the preventative therapy to the foot and/or leg, a user may place a portion of the plantar surface of the foot upon the foot support and then induce a rocking oscillation of the foot support to stimulate the foot and leg. The user may so stimulate the foot and/or leg for a therapeutically effective period of time to prevent venous thromboembolism and/or cause other beneficial effects.

In various aspects, the apparatus disclosed herein further includes a second foot support with one or more rockers engaged thereto and positionable between a deployed position and a storage position. The rockers engaged with the second foot support may be positioned in the deployed position, and the second foot support may oscillate thereupon to provide stimulus to a second foot and leg of the user. Accordingly, the user may utilize the foot support and the second foot support to stimulate both feet and legs simultaneously or sequentially. With the rockers associated with the foot support and the second foot support placed in the storage position, the foot support and the second foot support may be releasably engaged with one another for transport and/or storage. In various aspects, the assemblage of foot support coupled to the second foot support may be generally portable. The assemblage may be generally pocket sized in some aspects. In some aspects, the assemblage may generally define a rectangle with a side of the rectangle ranging between about 6 inches (15 cm) and about 8 inches (20 cm) in length and a second side of the rectangle ranging between about 4 inches (10 cm) and about 6 inches (15 cm) in length. The thickness of the assemblage may be generally less than 2 inches (5 cm) in various aspects, and, in some aspects, the thickness of the assemblage may be generally about 1 inch (2.5 cm).

Methods for the prevention of venous thromboembolism generally in the foot and leg are disclosed herein. In various aspects, the methods may include the step of positioning one or more rockers engaged with a foot support from a storage position into a deployed position. The methods may include the steps of engaging at least portions of a plantar surface of a foot with a surface of the foot support, and stimulating the foot and leg by oscillating the foot support in a rocking motion upon the one or more rockers whilst the foot is so engaged with the foot support.

Turning now to the Figures, it is to be recognized that the Figures referenced herein generally illustrate various exemplary implementations of the apparatus and the associated methods disclosed herein. These illustrated implementations are not meant to limit the scope of coverage, but, instead, to assist in understanding the context of the language used in this specification and in the claims. Accordingly, variations of the apparatus and methods that differ from these illustrated implementations may be encompassed by the appended claims that alone define the invention.

FIG. 1 illustrates an implementation of the apparatus 10 for the prevention of venous thromboembolism including foot rocker 12. The foot rocker 12 including foot support 20, rocker 30, and rocker 40 may be formed of plastic, wood, metal, or combinations thereof in various implementations, as would be recognized by those of ordinary skill in the art upon study of this disclosure. Other implementations may include more or fewer rockers. As illustrated, the foot rocker 12 includes rocker 30 and rocker 40 engaged with foot support 20. Rocker 30 and rocker 40 are illustrated in FIG. I as positioned in deployed positions 31, 41, respectively. Accordingly, rocker 30 and rocker 40 may rest upon surface 400, and oscillate upon surface 400 so that the foot support 20 may oscillate upon rocker 30 and rocker 40 with a rocking motion, as indicated by the curved arrows in the Figure. Surface 400 may be a floor, deck, or similar surface.

The foot support 20 defines surface 23 that engages the foot of the user. The foot support 20 including surface 23 may be generally sized and shaped to accommodate the foot of the user. In various implementations, the surface 23 may be made of a material that is comfortable when applied to the plantar surface of the foot. In various implementations, the surface 23 may be configured with ribs, nubs, various forms of roughness, textures, and so forth (not shown) that may enhance the engagement of the surface 23 with the plantar surface of the foot, portions of a shoe and/or stocking interposed between the plantar surface of the foot and surface 23, and/or provide stimulation to the foot.

Rocker 30 and rocker 40 are engaged with the foot support 20 and support the foot support 20 above the surface 400 when positioned in the deployed positions 31, 41, as illustrated in FIG. 1. Rocker 30 and rocker 40 in various implementation have a generally curved form such that, when positioned in the deployed positions 31, 41 upon surface 400, rocker 30 and rocker 40 and, hence, the foot support 20 engaged with rocker 30 and rocker 40 may oscillate upon surface 400 with a rocking motion. The curvature of the rockers 30, 40 could assume a variety of forms such as an essentially semi-circular form in some implementations, or a more parabolic or hyperbolic form in other implementations. Portions of rocker surfaces 32, 42 defined by rockers 30, 40, respectively rest upon surface 400, as illustrated in FIG. 1, and, accordingly, at least portions of rocker surfaces 32, 42 may be formed with various materials such as rubber and/or roughened in various ways that increase the friction between rocker surfaces 32, 42 and surface 400 in order to prevent generally the foot rocker 12 from sliding about surface 400 while oscillating upon surface 400. Rocker surfaces 32, 42 may be substantially flat in cross-section, may be curved in cross-section, or have various other cross-sectional shapes and these cross-sectional shapes may be chosen to enhance frictional contact between rocker surfaces 32, 42 and surface 400 or to enhance the instability of the rockers 30, 40 upon surface 400 in order to provoke the oscillatory rocking motion of the foot rocker 12.

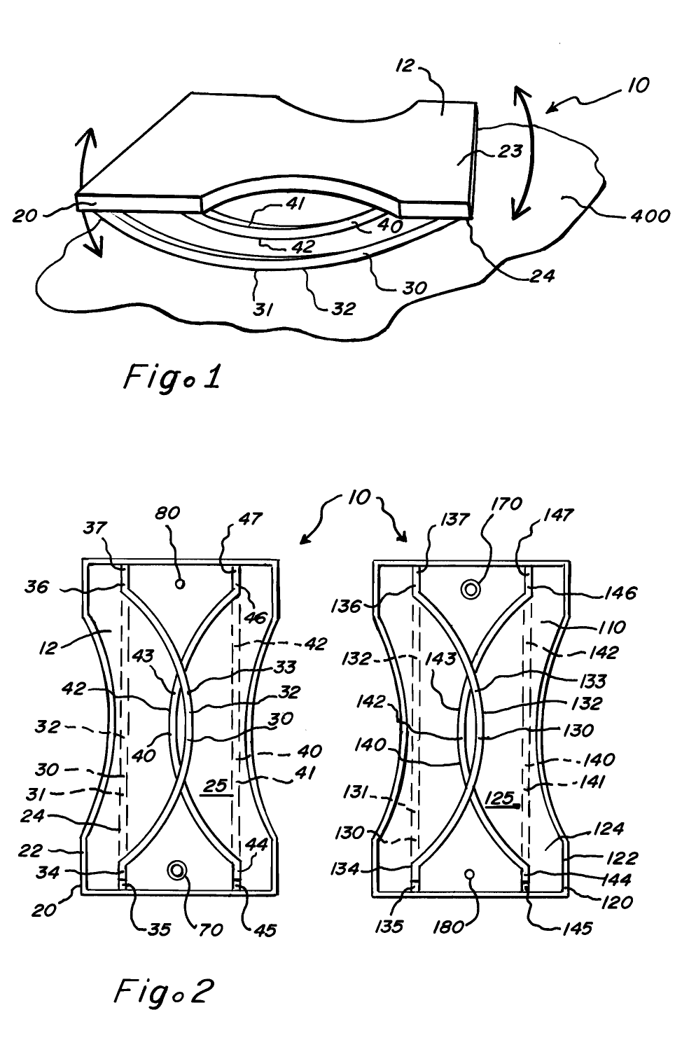

FIG. 2 illustrates an implementation of apparatus 10 that includes foot rocker 12 and further includes foot rocker 110. Foot support 20 of foot rocker 12, as illustrated in FIG. 2, is formed to define a rim 22 generally about the periphery and defines surface 24, with surface 24 being opposite to surface 23 (FIG. 1). The rim 22 in combination with the surface 24 of foot support 20 defines an open cavity 25 in this implementation. Rocker 30 and rocker 40 are hingedly secured to the foot support 20, and are illustrated in FIG. 2 as positioned in the storage position 33 and storage position 43, respectively, wherein rocker 30 and rocker 40 are generally disposed within the cavity 25 defined by the foot support 20. Rocker end 36 of rocker 30 is engaged with hinge 37 and rocker end 34 is engaged with hinge 35 in this implementation. As illustrated in FIG. 2, hinges 35, 37 allow rocker 30 to pivot in order to be positioned between the storage position 33 and the deployed position 31, which is illustrated in phantom. In this implementation, rocker end 46 of rocker 40 is engaged with hinge 47 and rocker end 44 is engaged with hinge 45. As illustrated in FIG. 2, hinges 45, 47 allow rocker 40 to pivot thereabout in order to be positioned between the storage position 43 and the deployed position 41 illustrated in phantom. Note that, as illustrated, portions of rocker 30 overlay portions of rocker 40 when rocker 30 and rocker 40 are positioned in the storage positions 33, 43. In various implementations, rocker 30 and/or rocker 40 may be notched (not shown) or otherwise configured to cooperate with one another when positioned in the storage positions 33, 43. In other implementations (not shown), rocker 30 may be generally separated from rocker 40 when rockers 30, 40 are positioned in the storage positions 33, 43.

As illustrated in FIG. 2, foot rocker 110 includes foot support 120, rocker 130, and rocker 140. Foot support 120 defines surface 123 (FIGS. 5A and 5B) adapted to engage at least portions of the plantar surface of the foot of the user. Rocker 130 and rocker 140 are engaged with the foot support 120. In this implementation, rocker 130 is positionable between a deployed position 131, which is illustrated in phantom in FIG. 2, and a storage position 133. Rocker 140, in this implementation, is positionable between a deployed position 141, which is illustrated in phantom, and storage position 143. Rocker 130 and rocker 140 support the foot support 120 above the surface 400 (FIG. 1) when positioned in the deployed positions 131, 141. Rocker 130 and rocker 140 have a generally curved form so that, when positioned in the deployed positions 131, 141 on surface 400, rocker 130 and rocker 140 oscillate upon surface 400 in order to impart rocking oscillatory motion to the foot support 120.

Foot support 120 of foot rocker 110, as illustrated in FIG. 2, is formed to define a rim 122 generally about the periphery and foot support 120 defines surface 124. The rim 122 in combination with the surface 124 of foot support 120 defines an open cavity 125 in this implementation. Rocker 130 and rocker 140 are hingedly secured to the foot support 120 and, when positioned in the storage position 133 and storage position 143, respectively, rocker 130 and rocker 140 are generally disposed within the cavity 125 defined by the foot support 120, as illustrated. Rocker end 136 of rocker 130 is engaged with hinge 137 and rocker end 134 is engaged with hinge 135 in this implementation. Hinges 135, 137 allow rocker 130 to pivot in order to be positionable between the storage position 133 and the deployed position 13 1 (illustrated in phantom). In this implementation, rocker end 146 of rocker 140 is engaged with hinge 147 and rocker end 144 is engaged with hinge 145. Hinges 145, 147 allow rocker 140 to pivot in order to be positioned between the storage position 143 and the deployed position 141 (illustrated in phantom).

In the implementation illustrated in FIG. 2, a male fitting 80 extends forth from surface 24 of foot support 20 to engage with socket 170 on surface 124 of foot support 120 (see FIG. 5C for more detail). A male fitting 180 similar to male fitting 80 extends forth from surface 124 of foot support 120 to engage with socket 170, which is similar to socket 70, on surface 124 of second foot support 120 in this implementation. With rockers 30, 40, 130, 140 positioned in storage positions 33, 43, 133, 143, male fitting 80 may be engaged with socket 170 and male fitting 180 may be engaged with socket 70 to releaseably secure foot rocker 12 and foot rocker 110 to one another with surface 24 and surface 124 oriented toward one another (see FIGS. 5A and 5B). Releaseably securing foot rocker 12 and foot rocker 110 to one another may facilitate transport and/or storage of apparatus 10. In various other implementations, more or fewer male fittings 80, 180 and corresponding sockets 170, 70 may be provided. Other mechanisms (not shown) may be provided in other implementations to allow foot rocker 110 and foot rocker 12 to be releaseably secured to one another in various other implementations.

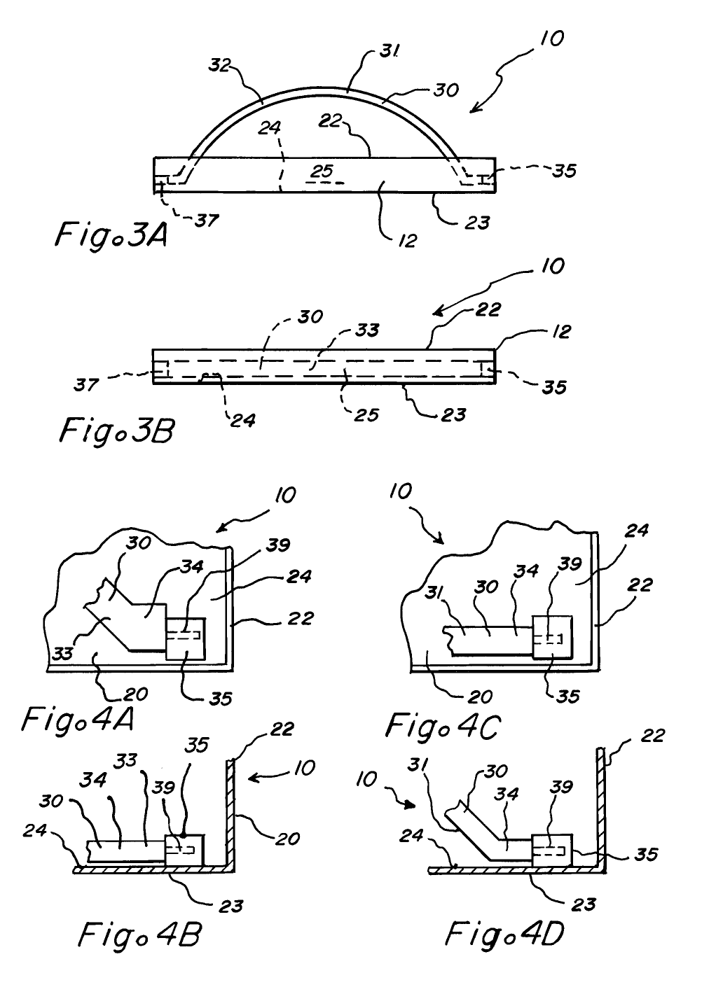

FIGS. 3A and 3B illustrate by side view rocker 30 in the deployed position 31 and storage position 33, respectively. As illustrated in FIG. 3A, rocker 30 extends forth from cavity 25 defined by rim 22 and surface 24 of foot support 20 when positioned in the deployed position 31. When rocker 30 is positioned in the storage position 33, as illustrated in FIG. 3B, rocker 30 is generally disposed within cavity 25. Rocker 40, when positioned in the storage position 43 (FIG. 2) may be similarly disposed within cavity 25, and rockers 130, 140 may be similarly disposed within cavity 125 when positioned in storage positions 133, 143 (FIG. 2) in various implementations in order that foot rocker 12 and foot rocker 110 may be secured to one another.

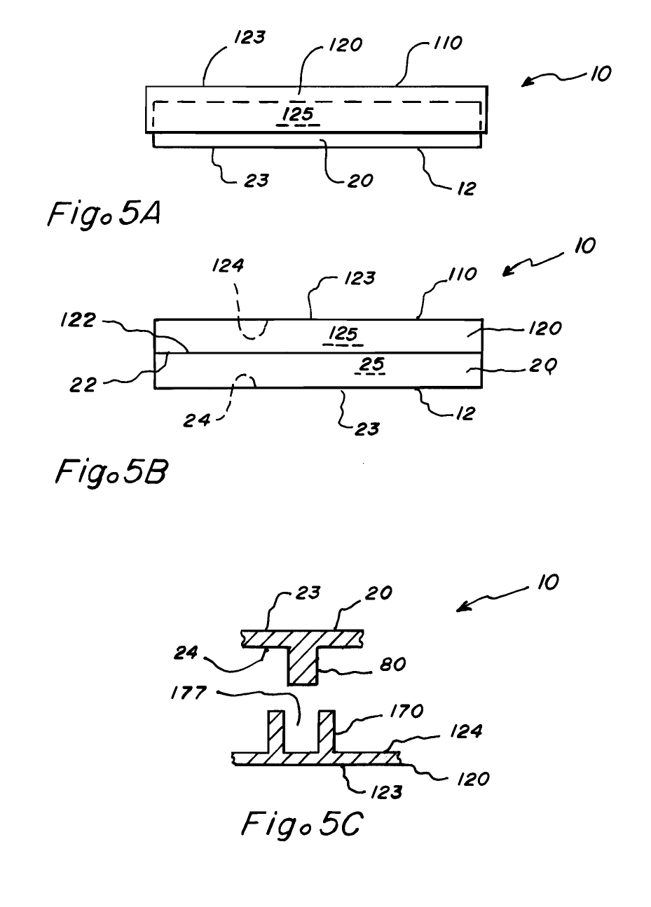

FIGS. 4A and 4B illustrate by top view and side cut-away view, respectively, portions of rocker 30 proximate exemplary hinge 35 with rocker 30 in the storage position 33. Hinges 37, 45, 47, 137, 145, 147 may be generally similar to hinge 35. As illustrated in FIGS. 4A and 4B, pin 39 extends forth from rocker end 34 to engage hinge 35. Rocker 30 may then be pivoted about pin 39 between the storage position 33 and the deployed position 31. Pin 39 may be formed as a part of rocker 30, for example, by molding in some implementations. In other implementations (not shown), the pin may be formed of metal or other suitable material separate from the rocker 30 and may be engaged with the rocker 30 and hinge 35. The hinge 35 may be formed in other ways, as would be recognized by those of ordinary skill in the art upon study of this disclosure, to allow the rocker 30 to be positioned between the storage position 33 and the deployed position 31 in other implementations.

FIGS. 4C and 4D illustrate by top view and side cut-away view, respectively, portions of rocker 30 proximate exemplary hinge 35 with rocker 30 in the deployed position 31. As illustrated in FIGS. 4C and 4D, pin 39 extends forth from rocker end 34 to engage hinge 35 to allow rocker 30 to be pivoted about pin 39 between the storage position 33 and the deployed position 3 1.

FIG. 5A illustrates foot rocker 12 secured to foot rocker 110 for transport and/or storage thereof. In this implementation, foot rocker 12 nests with foot rocker 110. As illustrated, foot rocker 12 is sized with respect to foot rocker 110 such that foot rocker 12 may be partially received within cavity 125 defined by foot support 120 of foot rocker 110. Surface 23 of foot support 20 and surface 123 of foot support 120 are oriented generally outward, as illustrated. Surface 123 engages the plantar surface of the foot when foot rocker 110 is utilized. Although not included in this Figure, rockers 30, 40, 130, 140 are contained in cavity 125 in this implementation when foot rocker 12 is secured to foot rocker 110. Male fitting 80 may be engaged with socket 170 and male fitting 180 may be engaged with socket 70 in a similar fashion to releaseably secure foot rocker 12 and foot rocker 110 to one another in this implementation. In other implementations, other latches or suchlike may be provided to releasably secure foot rocker 12 to foot rocker 110.

FIG. 5B illustrates another implementation wherein foot rocker 12 is secured to foot rocker 110. In this implementation, rim 22 of foot rocker 12 and rim 122 of foot rocker 110 are engaged with one another so that surface 24 is oriented toward surface 124 and cavities 25 and 125 are combined and rockers 30, 40, 130, 140 (not included in FIG. 5B) are contained therein. Male fitting 80 may be engaged with socket 170 and male fitting 180 may be engaged with socket 70 to releaseably secure foot rocker 12 and foot rocker 110 to one another. Various other latches or suchlike may be provided to releasably secure foot rocker 12 to foot rocker 110 in other implementations.

FIG. 5C illustrates an implementation of male fitting 80 and socket 170. As illustrated, male fitting 80 may be releasably received within socket cavity 177 defined by socket 170. Various flanges, notches, and so forth may be provided about male fitting 80 and socket 170 to allow releasable engagement between male fitting 80 and socket 170, as would be recognized by those of ordinary skill in the art upon study of this disclosure.

In operation, the apparatus for the prevention of venous thromboembolism generally in the foot and leg disclosed herein, for example apparatus 10, may be utilized by positioning one or more rockers such as rocker 30 and rocker 40 engaged with a foot support such as foot support 20 from a storage position such as storage position 33 and storage position 43 into a deployed position such as deployed position 31 and deployed position 41 and then placing the foot rocker such as foot rocker 12 upon a surface. The user may then engage at least portions of a plantar surface of the user's foot with, for example, surface 23 of the foot support 21. Either foot may be so engaged. The user may be seated, or the user may stand upon one foot—leg and engage the other foot and leg with the foot rocker 12. When standing, the foot—leg not engaged with the foot rocker may bear most of the user's weight and stabilize the user while the apparatus 10 is employed.

The plantar surface of the foot may be engaged with surface 23 while shod so that a sole of a shoe or sandal or other footwear and, possibly, a sock are interposed between the plantar surface and surface 23 of the foot rocker 12 in some implementations. In other implementations, the bare plantar surface of the foot may directly engage the surface 23, and in yet other implementations, the user may be stocking footed so that a sock is interposed between the plantar surface and surface 23. With the plantar surface engaged with surface 23, the foot of the user is then oscillated upon the foot rocker 12 in a rocking motion thereby delivering a stimulus to the foot and/or leg. The stimulus to the foot and leg may be delivered, at least in part, by dorsi flexion and plantar flexion of the foot caused by the rocking oscillation of the foot support with at least portions of the plantar surface of the foot engaged therewith.

Curved rockers such as rockers 30, 40 are generally unstable when placed upon surface 400 so that the foot rocker such as foot rocker 12 invites the oscillating rocking motion when the user's foot is applied thereto. The rocking motion with the plantar surface engaged with the surface 23 of foot rocker 12 may be continued for such time as a therapeutically effective stimulus for the prevention of venous thromboembolism is delivered to the user's foot and/or leg. The plantar surface of the foot may be engaged with the foot rocker such as foot rocker 12 periodically in order to stimulate repeatedly the foot and/or leg, for example during long period of inactivity, in order to maintain venous circulation in the foot and leg.

In various aspects, the user may employ a second foot rocker such as foot rocker 110 to stimulate the other foot and corresponding leg. For example, the user may use both foot rocker 12 and foot rocker 110 to stimulate both feet and legs simultaneously, or sequentially. In some aspects, the user may use a single foot rocker such as foot rocker 12 and may use the single foot rocker to stimulate both feet and legs sequentially.

When a second foot rocker is employed, such as foot rocker 110, the foot rocker 110 may be detached from, for example, foot rocker 12. With continuing exemplary reference to foot rocker 110, following detachment, rocker 130 is positioned from the storage position 133 into the deployed position 131 and rocker 140 is positioned from the storage position 143 into the deployed position 141 and the rockers placed upon a surface such as surface 400. The user, who may be seated, may then engage the plantar surface of the foot with the surface 123 of foot rocker 110 and stimulate the foot by oscillating the foot rocker 110 in a rocking motion. This may be done either simultaneously or sequentially with engagement with the other foot with, for example, surface 23 of foot rocker 12.

Upon completion of delivery of the preventive therapy, rockers 30, 40 of foot rocker 12 may be positioned from the deployed positions 31, 41 into the storage positions 33, 43. Rockers 130, 140 of foot rocker 110 may be positioned from the deployed positions 131, 141 into the storage positions 133, 143. With rockers 30, 40 in storage positions 33, 43 and rockers 130, 140 in storage positions 133, 143, foot rocker 12 and foot rocker may be releaseably engaged with one another, which may enhance the user's ability to transport and or store the apparatus 10. In various aspects, foot rocker 12 and foot rocker 110 may nest with one another.

The foregoing detailed description discloses and describes various exemplary implementations. Upon study of the specification, one of ordinary skill in the art may readily recognize from the detailed description and from the accompanying figures and claims that various changes, modifications and variations can be made therein without departing from the spirit and scope of the inventions as defined in the following claims.

What is claimed is:

1. A foot rocker for the prevention of venous thromboembolism generally in the foot and leg, comprising:
a foot support adapted to generally receive at least portions of a plantar surface of a foot thereupon;
a rocker engaged with the foot support and positionable between a storage position and a deployed position, the rocker in the deployed position supports the foot support such that the foot support is oscillatable with a rocking motion stimulative to the foot and leg.

1. The apparatus, as in claim 1, wherein the rocking motion of the foot support is stimulative to the foot and leg by causing dorsi flexion and plantar flexion of the foot engaged therewith that enhances venous blood flow thereabout.

2. The apparatus, as in claim 1, further comprising: a second rocker engaged with the foot support and positionable between a storage position and a deployed position, the second rocker in the deployed position supports the foot support while allowing the foot support to oscillate with a rocking motion.

3. The apparatus, as in claim 1, wherein the foot support defines a cavity that generally receives the rocker when the rocker is positioned in the storage position.

4. The apparatus, as in claim 1, wherein portions of the rocker are surfaced with non-skid material.

5. The apparatus, as in claim 1, wherein portions of the foot support are surfaced in ways stimulative to the foot.

6. The apparatus, as in claim 1, further comprising:
a second foot support with a second foot support rocker engaged thereto, the second foot support rocker positionable between a storage position and a deployed position, the second foot support rocker in the deployed position supports the foot support while allowing the foot support to oscillate with a rocking motion, the foot support and the second foot support nestably receive one another with the rocker in the storage positions and the second foot support rocker in the storage position.

7. The apparatus, as in claim 6, further comprising:
an attachment mechanism that releasably secures the foot support to the second foot support when the foot support and the second foot support are nestably received with one another.

8. The apparatus, as in claim 1, further comprising:
a second foot support with a second foot support rocker engaged thereto, the second foot support rocker positionable between a storage position and a deployed position, the second foot support rocker in the deployed position supports the foot support while allowing the foot support to oscillate with a rocking motion, the foot support and the second foot support are detachably securable to one another with the rocker in the storage positions and the second foot support rocker in the storage position.

9. A foot rocker for the prevention of venous thromboembolism generally in the foot and leg, comprising:
a foot support;
one or more rockers engaged with the foot support and positionable between a storage position and a deployed position, the one or more rockers positioned in the deployed position;
at least portions of a plantar surface of a foot engaged with a surface of the foot support, the foot support oscillates upon the one or more rockers in a rocking motion that causes dorsi flexion and plantar flexion of the foot engaged therewith that enhances venous blood flow about the foot and leg.

10. A method for the prevention of venous thromboembolism generally in the foot and leg, comprising the steps of:
positioning one or more rockers engaged with a foot support from a storage position into a deployed position;
engaging at least portions of a plantar surface of a foot with a surface of the foot support following the step of positioning one or more rockers engaged with a foot support from a storage position into a deployed position; and
causing dorsi flexion and plantar flexion of the foot by oscillating the foot support with at least portions of the plantar surface of the foot engaged therewith in a rocking motion upon the one or more rockers.

11. The method, as in claim 10, further comprising the steps of:
positioning one or more rockers engaged with a second foot support from a storage position into a deployed position;
engaging at least portions of a plantar surface of a second foot with a surface of the second foot support following the step of positioning one or more rockers engaged with a second foot support from a storage position into a deployed position; and
causing dorsi flexion and plantar flexion of the second foot by oscillating the second foot support with at least portions of the plantar surface of the second foot engaged therewith in a rocking motion upon the one or more rockers engaged thereto.

12. The method, as in claim I 1, further comprising the steps of:
positioning the rockers from the deployed position into the storage position following the step of causing dorsi flexion and plantar flexion of the foot; and
securing releasably the foot support and the second foot support to one another.

13. The method, as in claim 12, wherein the foot support and the second foot support are nestably secured to one another.

14. The method, as in claim 10, wherein the step of causing dorsi flexion and plantar flexion of the foot by oscillating the foot support with at least portions of the plantar surface of the foot engaged therewith in a rocking motion upon the one or more rockers is performed for a period of time effective for the prevention of venous thromboembolism generally in the foot and leg.

15. The method, as in claim 10, wherein the step of causing dorsi flexion and plantar flexion of the foot by oscillating the foot support with at least portions of the plantar surface of the foot engaged therewith in a rocking motion upon the one or more rockers is performed for a period of time effective for the relief of edema generally in the foot and leg.

16. The method, as in claim 10, wherein the step of causing dorsi flexion and plantar flexion of the foot by oscillating the foot support with at least portions of the plantar surface of the foot engaged therewith in a rocking motion upon the one or more rockers is performed by a user generally in a seated position.
